(19) United States
(12) Patent Application Publication
(10) Pub. No.: US 2006/0059209 A1
(43) Pub. Date: Mar. 16, 2006

(54) Crash recovery by logging extra data

(76) Inventor: Scott David Lashley, Portland, OR (US)

Correspondence Address: INTELLECTUAL PROPERTY LAW OFFICE, 1901 S. BASCOM AVENUE, SUITE 660, CAMPBELL, CA, 95008, US

(21) Appl. No.: 10/941,542

(22) Filed: Sep. 14, 2004

(51) Int. Cl. G06F 17/30

(52) U.S. Cl. 707/202

(57) ABSTRACT

A method for crash recovery in a data base management system (DBMS). A plurality of pages of data are loaded sequentially as a block from a fast recovery log into a bufferpool, wherein these pages have respectively been pre-stored into the fast recovery log to construct the block. A plurality of logical operations are then applied from a logical log to the pages in the bufferpool to return the DBMS to a transactionally consistent state.

### BACKGROUND OF THE INVENTION

1. Field of the Invention

The present invention relates to data processing apparatus and corresponding methods for the retrieval of data stored in a database or as computer files. More particularly, the invention relates to file recovery for database management.

2. Description of the Prior Art

Individuals and organizations are increasingly storing data electronically in databases, a collection of the data arranged for ease of storage, retrieval, updating, searching, and sorting by computerized means. As the size, number, and complexity of such databases grow, sophisticated Data Base Management Systems (DBMS) are continually being developed and improved to facilitate database use and management. In a modern DBMS the data may be stored at multiple, non-contiguous locations, within one storage volume, or spanned across multiple volumes. Such a DBMS may be used for multiple purposes, often by multiple users, effectively concurrently.

FIG. 1 (background art) is a block diagram conceptually depicting the basic elements and operation of a representative DBMS 10. The DBMS 10 includes a database engine 12, a database 14, a buffer pool 16, and a logical log 18.

FIG. 2 (background art) is a block diagram conceptually depicting the contents of the database 14 as tables 20, for example, T₁ . . . Tₙ, where each represents a data store. The database 14 resides in persistent storage and in actual practice may contain a lesser or greater number of tables 20 than are shown. Typically, a database 14 contains many tables 20.

FIG. 3 (background art) is a block diagram conceptually depicting the contents of a table 20, as a plurality of records 22. It is not unusual for a table 20 to contain thousands of records 22 that applications work with when performing transactions involving queries and updates.

FIG. 4 (background art) is a block diagram conceptually depicting the contents of a table 20 as pages 24, for example, P₁ . . . Pₙ, that store data in a manner easy to retrieve and reference in future transactions. A page 24 is the smallest unit of data that the database engine 12 retrieves into or writes out of the buffer pool 16.

FIG. 5 (background art) is a block diagram conceptually depicting the contents of the table 20 of FIG. 4 again, now grouped as pages 24 in an extent 26. An extent 26 is a set of logically contiguous pages 24 in a table 20, and the table 20 consists of a set of such extents 26, for example E₁ . . . Eₙ. While the pages 24 that comprise a table 20 are contiguous, it should be noted that the extents 26 that comprise a table 20 are not necessarily contiguous. [The use of extents and pages is simply a common way of referring to how data is stored. Some practitioners in this are think in terms of extents and others in terms of pages.]

In operation, an application provides a query or an update to the database engine 12 and it directs retrieval and storage of instances of the pages 24 or extents 26 from the database 14 into the buffer pool 16 that contain the needed data. As pages 24 are brought into and out of the buffer pool 16 the data is often spoken of as being “paged into” and “paged out” of memory. A “page fault” occurs when a page 24 has to be paged into the buffer pool 16 because it is not already there. When a page 24 contains updates that are not yet recorded in the database 14 it is a “dirty” page 24. The operation of paging out a dirty page 24 from the buffer pool 16 into the database 14 is often referred to as “flushing.” Conversely, when a page 24 with no updates is paged out, this operation is often referred to as “replacing.” Page faults and having to flush dirty pages 24 are generally undesirable because they slow down operation of the DBMS 10.

The buffer pool 16 resides in high speed, volatile memory and the rationale for using it, rather than simply working directly with the database 14, is to increase the efficiency based on the principles of probability. If the DBMS 10 is being used by an application to perform a query or update on a record 22 in a table 20, the page 24 containing that record 22 is likely to contain other records 22 that will soon also be the subject of queries or updates. For that matter, other pages 24 in the extent 26 containing the page 24 are also likely to also contain other records 22 that may be the subject of queries or updates soon. Accordingly, it is usually desirable to not page out a page 24 after a query or update finishes with it, but rather to retain it in the buffer pool 16 until it has not been accessed for some period of time or until the application using it ends.

Additionally, more than one type of pages 24 can be stored in the buffer pool 16. For instance, a large number of commonly referenced, general read-only pages 24 may be stored as well. Such “hot” pages 24 are often stored continuously in the buffer pool 16 while an application is active because they are frequently referenced.

Of present interest, when an update is performed the database engine 12 needs to page out the dirty page 24 at some point and this is where things get complicated. Unplanned disruptions in the DBMS 10 can occur, causing the contents of the buffer pool 16 to not get properly flushed to the database 14. Such an event is termed a “crash” and the process of restoring the data stored in the database 14 to a transactionally consistent state after a crash is often referred to as “crash recovery.”

FIG. 6 (background art) is a block diagram conceptually depicting the contents of the logical log 18 in the DBMS 10. To facilitate crash recovery, each of the updates applied to the tables 20 has a logical representation entered as a log record 28 in the logical log 18, for example LR₁ . . . LRₙ. Every update is also recorded according to its time of entry into the database 14. Since a log record 28 for each update is input into the logical log 18, multiple log records 28 for the same page 24 may end up being recorded. In the event of a crash, the logical log 18 is used to replay or redo all of the committed updates that were applied to the tables 20. Thus, in addition to storing data in the database 14, a sophisticated database engine, such as the database engine 12 here, also records the updates performed on the data in the logical log 18. The logical log 18 resides in persistent storage, possibly even in the same persistent storage or “tablespace” as the database 14.

FIG. 7 (background art) is a flow chart depicting an overview of an example update process 50 for updating the data in the DBMS 10. In a step 52 the update process 50 starts and in a step 54 optional general initialization can be performed.

In a step 56, the database engine 12 determines whether the page 24 containing the data about to be updated is already present in the buffer pool 16. If not, a page fault has occurred and that page 24 has to be retrieved. Accordingly, in a step 58 the database engine 12 locks specific portions of the page 24 in the database 14, such as one or more data records 22, to protect that data in the database 14 while it is present in the buffer pool 16. Then, in a step 60, the needed page 24 is retrieved from the database 14. Once a page 24 is introduced in this manner, the extent 26 that it is part of may also be pulled into the buffer pool 16, since there is a high likelihood that other pages 24 in that extent 26 may soon be referenced for updates as well.

Continuing, in a step 62 the database engine 12 locks the subject page 24 in the buffer pool 16, thus halting other activity on it while the update is being performed. In a step 64, the database engine 12 applies the update as needed to the page 24 of locked data. Regardless of whether the page 24 was already in the buffer pool 16, and possibly even previously updated, it is now a dirty page 24.

In a step 66, the database engine 12 records the update in the logical log 18, and in a step 68 the lock on the subject dirty page 24 in the buffer pool 16 is released. In a step 70, the database engine 12 carries on, potentially further using the dirty page 24.

At some point, in a step 72, the dirty page 24 is flushed by writing it back into the database 14 and, after this, in a step 74 the database engine 12 releases the lock on the specific portions of the page 24 in the database 14 that were locked back in step 58.

Finally, in a step 76, optional general wrap-up can be performed and in a step 78 the update process 50 is finished.

FIG. 8 (background art) is a flow chart depicting an overview of an example crash recovery process 100 after a disruption in the DBMS 10. Crash recovery has three basic phases. The first of these is a pre-transaction recovery phase 102 (also often termed “infrastructure boot”), for infrastructure initialization of the database engine 12; the second is a transaction recovery phase 104; and the third basic phase is a post-transaction recovery phase 106, for further infrastructure initialization of the database engine 12.

In a step 108 the crash recovery process 100 starts, and in a step 110 optional general initialization can be performed. Typically, crash recovery in a DBMS 10 occurs on the database 14 while it is in a quiescent state, meaning that no update activity is allowed to be performed on the database 14 while the database engine 12 is in the phases 102, 104, 106 of the crash recovery process 100.

In a step 112, the database engine 12 infrastructure is initialized. This includes allocating required resources such as memory, opening storage required for the database 14, etc. This ends the pre-transaction recovery phase 102. This phase is not particularly germane to this disclosure and therefore not discussed further.

In the transaction recovery phase 104 updates that were recorded into the logical log 18 but never flushed are applied to the database 14. The transaction recovery phase 104 typically includes two sub-phases, transaction roll forward, also referred to as “logical replay,” in which updates recorded in the logical log 18 are applied, and transaction roll back, where incomplete application transactions are undone to bring the database 14 into an application transactionally consistent state.

In a step 114, a log record 28 is retrieved from the logical log 18. There is always at least one log record 28 in the logical log 18. Typically, the DBMS 10 does periodic checkpoints in which it writes out to persistent storage information about the DBMS 10. As part of that information, it writes out a ‘begin crash recovery LSN’ to a checkpoint in persistent storage (not shown; typically different storage than the logical log 18). This is a pointer into the logical log 18 where roll forward is to begin. Even if there are no transactions active and every dirty page 24 has been flushed, there will still be such a pointer to a particular LSN within the logical log 18, so that roll forward has a known place to start. This has the additional benefit of providing a way to detect corruption, because one knows the logical log 18 has been corrupted if the restart LSN is not valid.

In a step 116, a determination is made if the end of the logical log 18 has been reached. If so, the transaction roll forward sub-phase is finished and the transaction roll back sub-phase can begin. The transaction roll back sub-phase and the post-transaction recovery phase 106 are discussed presently.

If the end of the logical log 18 has not been reached, in a step 118 a determination is made if the page 24 containing the data which the log record 28 applies to is already in the buffer pool 16. If the page 24 is not in the buffer pool 16, a page fault has occurred and the page needs to be retrieved. Accordingly, in a step 120 the page 24 (or the entire extent 26 containing it) is retrieved into the buffer pool 16 from the database 14.

In a step 122, a determination is next made if the log record 28 should be applied to the page 24. For example, if two pages (P₁ and P₂) are updated at respective times (T₁ and T₂; with T₁<T₂). If only P₂ has been flushed when there is a crash, the roll forward start point will be somewhere in the logical log 18 prior to the updates for both pages. Roll forward will then “see” logical log 18 updates for both P₁ and P₂. When the update for P₁ is encountered it is applied, but there is no point in applying the update for P₂, since it was already applied prior to the crash.

If the log record 28 should be applied, in a step 124 the database engine 12 locks the page 24 to be updated in the buffer pool 16, applies the log record 28 to update that page 24, and releases the lock on this dirty page 24 in the buffer pool 16. It should be noted in passing that row locks in the database 14 are not needed during logical replay, unlike in the update process 50.

After all of this, or if the log record 28 is not being applied, the crash recovery process 100 returns to step 114.

Picking up at step 116, if the end of the logical log 18 has been reached, in a step 126 transaction roll back is performed and the transaction recovery phase 104 is complete. Transaction roll back is the process of backing out updates to the DBMS for all non-terminated (neither committed nor rolled back) transactions. Each non-terminated transaction is rolled back by reading the logical log in reverse and undoing each update. To facilitate this process, in the logical log 18 the log records 28 within a transaction are back linked (each log record 28 points to a previous log record 28 within the same transaction).

In a step 128, the database engine 12 infrastructure is further initialized, typically by going through a process that changes the database from an inconsistent state to a consistent one so that application transactions can commence. Finally, in a step 130, optional general wrap-up can be performed, and in a step 132 the crash recovery process 100 is finished.

As databases have grown in importance and use, it has become increasingly desirable that DBMS performance be optimized. Crash recovery is no exception to this and, in fact, it is often a very important area for optimization. In many applications it is desirable or even critical that a database be returned to service as soon as possible after a crash. Unfortunately, even with optimization in other respects, crash recovery can require access to hundreds or even thousands of pages, potentially performing updates to most of those pages.

As matters exist now, the ability to access the data in a database after a crash is largely arbitrary, and this often poses a substantial inconvenience to users. Depending on the order of the pages or extents of data brought into the buffer pool for a logical replay, and when any particular update starts, having the particular data needed in the buffer pool to apply the log records is based on random I/O.

In attempting to remedy this problem the prior art has focused largely on avoiding the redo of in-doubt data. Instead of actually applying log records immediately, the object in this approach is to identify the in-doubt data and block access to it. Once all of the in-doubt data is locked in this manner, access to the DBMS is restored and the in-doubt data is brought into a transactionally consistent state in a leisurely fashion. Should any new transactions require access to the in-doubt data before it is restored, that access simply is blocked. This gives the appearance of the DBMS being able to quickly recover after a crash but, in reality, much data remains locked for an extended period of time. Even worse, this particular data is often that which is then most important, since it was this data that was in the buffer pool at the time of the crash and probability dictates that it is the very data that will most likely be needed again by queries and updates. For example, most applications will want to re-submit their in-flight transaction that just got aborted because of a crash, but the transactions will be blocked until log replay has completed.

It is, therefore, an object of the present invention to provide an improved crash recovery system. Other objects and advantages will become apparent from the following disclosure.

### SUMMARY OF THE INVENTION

Briefly, one preferred embodiment of the present invention is a method for crash recovery in a data base management system (DBMS). A plurality of pages of data are loaded sequentially as a block from a fast recovery log into a bufferpool. These pages have respectively been pre-stored into the fast recovery log to construct said block. A plurality of logical operations are then applied from a logical log to the pages in the bufferpool, to return the DBMS to a transactionally consistent state.

Briefly, another preferred embodiment of the present invention is a method for building a fast recovery log for use in crash recovery in a DBMS having a bufferpool and pages of data. A transaction is received to update the data in a particular page. That particular page is first insured to be in the bufferpool. The particular page is then updated in the bufferpool, in accord with the transaction. The transaction is logged into a logical log in non-volatile storage. The particular page is then recorded in a fast recovery log in non-volatile storage. The operation of insuring that the particular page is in the bufferpool occurs after receiving the transaction. The operation of updating the particular page in the bufferpool occurs after insuring the particular page is present in the bufferpool. The operation of logging the transaction into the logical log occurs after updating the particular page in the bufferpool. And the operation of recording the page in the fast recovery log occurs after insuring the particular page is present in the bufferpool.

Briefly, another preferred embodiment of the present invention is an improved DBMS, of the type in which a database engine performs an update on data in a page in a database by moving the page into a bufferpool, applying the update to the data in the page in the bufferpool, and writing the page back into the database from the bufferpool. The database engine also stores a log record for the update in a logical log, to permit recovery of the database to a transactionally consistent state after an event where the bufferpool is disrupted before the page in the bufferpool is written into the database. The improvement to the DBMS includes a fast recovery log in which the database engine stores the page of data in a manner that facilitates sequential loading of the page along with a plurality of other such pages into the bufferpool, thereby seeding the bufferpool before the database engine applies the log record after a disruption.

Briefly, another preferred embodiment of the present invention is a system for crash recovery in a DBMS having a bufferpool, a plurality of pages of data in a database, and a logical log to contain log records of updates to the data. A fast recovery log is provided to contain seed pages of the data. A database engine receives the updates for particular data from the plurality of pages of the data in the database. The database engine insures that the pages containing the particular data are in the bufferpool. The database engine then applies the updates. The database engine next logs the log records of the updates to the data into the logical log. The database engine also records the particular pages as at least one sequential block of said seed pages in said fast recovery log. The database engine is able to retrieve the sequential blocks of seed pages in the fast recovery log into the bufferpool. The database engine can replay the log records of the updates to the data from the logical log, thereby returning the DBMS to a transactionally consistent state.

It is an advantage of the present invention that many small, random I/O operations in crash recovery of a DBMS are replaced by a few large sequential I/O operations. This improves crash recovery performance noticeably.

It is another advantage of the present invention that, once the database of the DBMS is recovered, the buffer of the DBMS is “warm” and allows applications using the DBMS to achieve peak performance sooner.

These and other features and advantages of the present invention will no doubt become apparent to those skilled in the art upon reading the following detailed description which makes reference to the several figures of the drawing.

### IN THE DRAWINGS

The following drawings are not made to scale as an actual device, and are provided for illustration of the invention described herein.

FIG. 1 (background art) is a block diagram conceptually depicting the basic elements and operation of a representative database management system (DBMS).

FIG. 2 (background art) is a block diagram conceptually depicting the contents of the database in FIG. 1 as tables.

FIG. 3 (background art) is a block diagram conceptually depicting the contents of a table as a plurality of records.

FIG. 4 (background art) is a block diagram conceptually depicting the contents of a table as pages.

FIG. 5 (background art) is a block diagram conceptually depicting the contents of the table of FIG. 4 again, now grouped as pages in an extent.

FIG. 6 (background art) is a block diagram conceptually depicting the contents of the logical log in the DBMS of FIG. 1.

FIG. 7 (background art) is a flow chart depicting an overview of an example update process for updating the data in the DBMS of FIG. 1.

FIG. 8 (background art) is a flow chart depicting an overview of an example crash recovery process after a disruption in the DBMS of FIG. 1.

FIG. 9 is a block diagram conceptually depicting the basic elements and operation of a crash recovery system in accord with the present invention.

FIG. 10 is a block diagram conceptually depicting the contents of the fast recovery log in of FIG. 9.

FIG. 11 is a flow chart depicting an overview of an update process for updating the data in a DBMS in accord with the present invention.

FIG. 12 is a flow chart depicting a crash recovery process in accord with the present invention.

In the various figures of the drawings, like references are used to denote like or similar elements or steps.

### DETAILED DESCRIPTION OF THE PREFERRED EMBODIMENTS

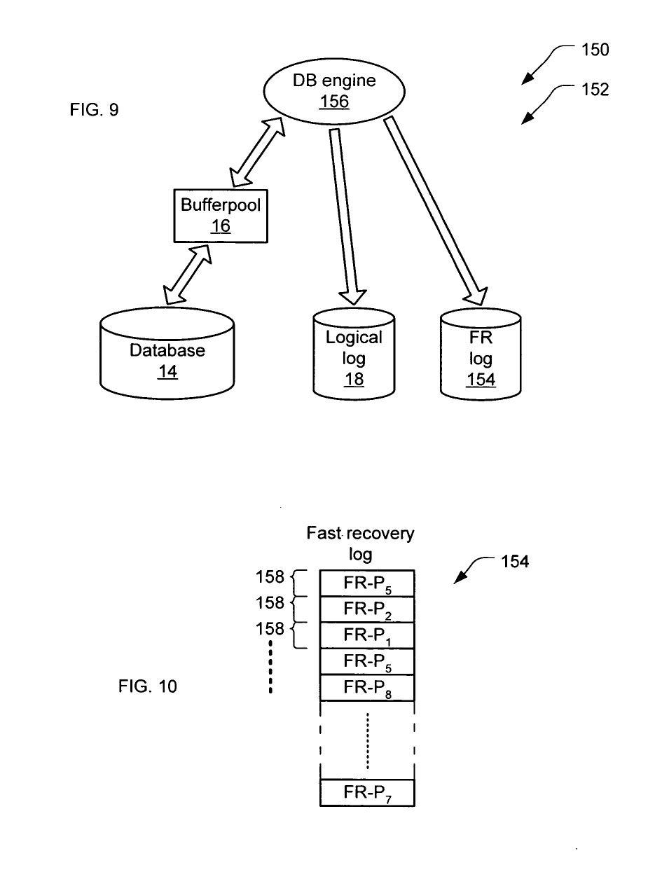

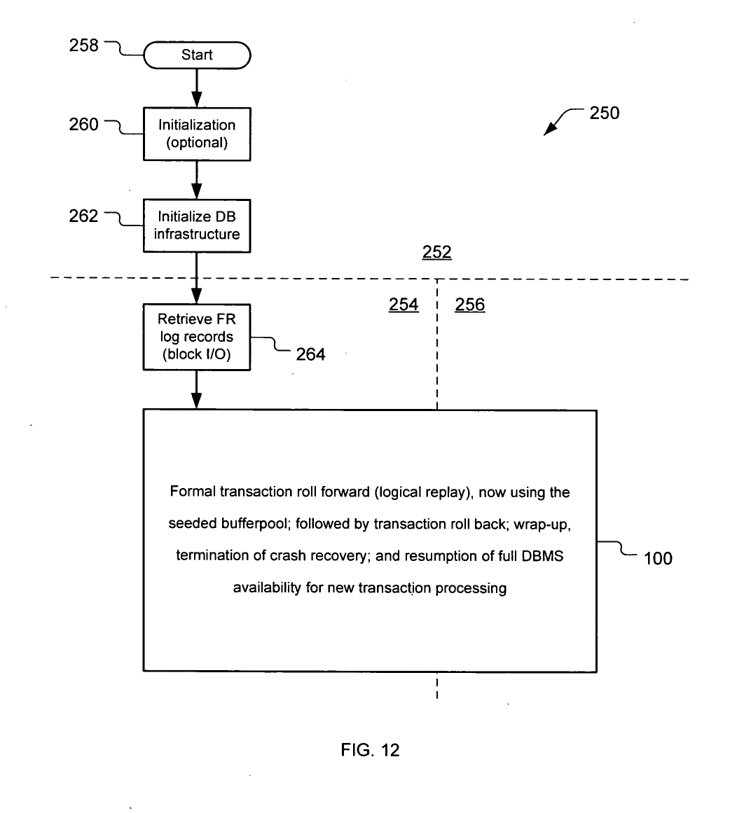

Briefly, this invention eases or solves the problem of random read accesses, or random input (I/O), that affects performance when performing crash recovery of a database 14. Such random I/O occurs as log records 28 are processed during the replay of a logical log 18 to apply the data, index, and log pages referenced in the log records 28. The approach proposed for this, described in more detail below, is to provide and employ a separate area in persistent storage to contain copies of the pages 24 needed for crash recovery. This storage area is termed a “fast recovery log” and, unlike the contents of the logical log 18, the pages in the fast recovery log are stored such that they can be loaded into the buffer pool 16 sequentially. This provides improved crash recovery by replacing multiple relatively slow random I/Os with as few as a single large block, sequential I/Os. As illustrated in the various drawings herein, and particularly in the views of FIGS. 9 and 12, exemplary embodiments of the invention are depicted by the general reference characters 150 and 250.

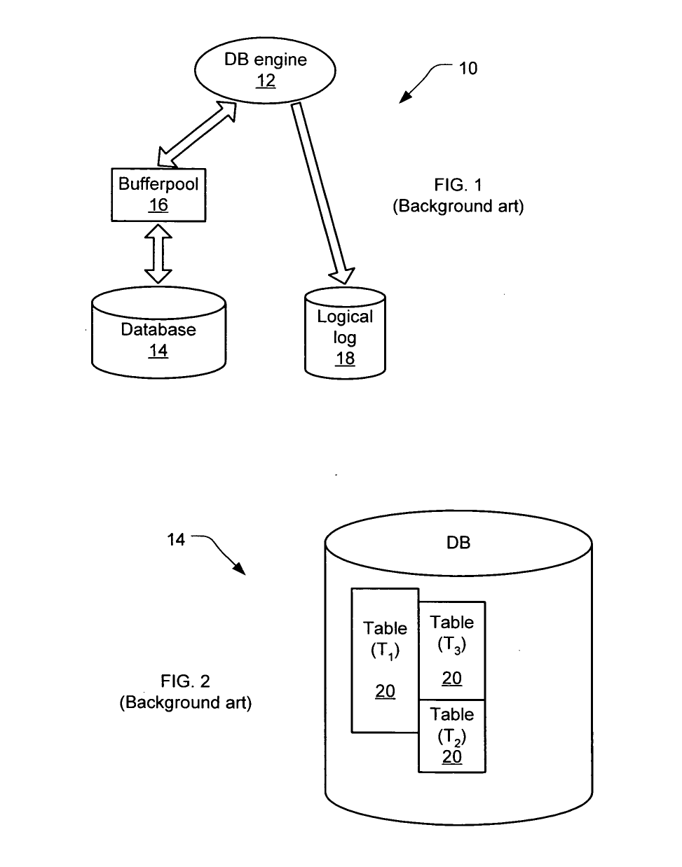

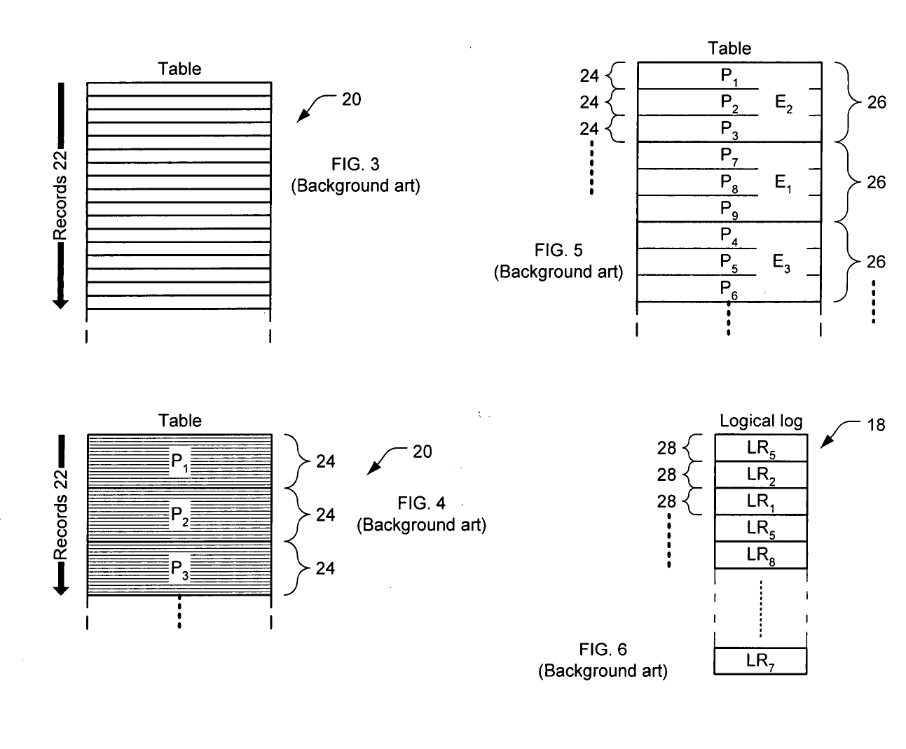

FIG. 9 is a block diagram conceptually depicting the basic elements and operation of a crash recovery system 150 in accord with the present invention. The crash recovery system 150 is employed in the context of a database management system (DBMS 152) that may be equivalent in many respects to the DBMS 10 (FIG. 1) previously described. Already introduced reference characters are reused below, where appropriate.

As can be seen, the DBMS 152 differs only slightly from the DBMS 10. A fast recovery log 154 is added and a database engine 156 is now used that can work with the fast recovery log 154 as well as the rest of the DBMS 152.

FIG. 10 is a block diagram conceptually depicting the contents of the fast recovery log 154. Specifically, the contents are update pages 158 (FR-P₁ . . . FR-Pₙ) that are images of the pages 24 being updated, and thus images also of the pages 24 required during logical replay on the database 14 for crash recovery.

The database engine 156 can record images of pages 24 into respective update pages 158 at two points. It may log them as before-images, capturing each image prior to an update being applied. Alternately, the database engine 156 may log the update pages 158 as after-images, capturing each image after an update has occurred. Both the before-image and the after-image approaches can be used, but the inventors prefer the after-image approach because it provides some implementation efficiencies.

If the fast recovery log 154 includes before-images, it may be necessary to retrieve additional pages 24 from the database 14 to supplement crash recovery, since it is possible that some pages 24 are not in the buffer pool 16 and will need to be recalled to resume recent updates to those pages 24. However, this approach is still significantly more efficient since the buffer pool 16 will still contain most of the pages 24 necessary for crash recovery.

Of course, if the fast recovery log 154 includes captured after-images, nearly all of the pages 24 are then present in the buffer pool 16 and nominal, if any, access to the database 14 is required for crash recovery. Using after-images, as compared to before-images, thus more quickly expedites the crash recovery process.

The fast recovery log 154 is a storage area defined by the database engine 156 that is used to store copies of pages 24 from other tablespaces (the formal database 14). The fast recovery log 154 should preferably not be larger than the amount of memory dedicated to the buffer pool 16, but should be large enough to hold all of the “hot” pages 24 as well as those pages 24 needed by crash recovery. Typically, the size of the fast recovery log 154 is not hard to configure because applications can configure the length of crash recovery using configuration parameters.

The pages required for transactional correctness of a crash recovery continually change based on two factors: less frequently used pages 24 in the bufferpool 16 are flushed to the database 16 and replaced or dirty pages 24 that have not been flushed after an extended period of time are flushed in order to move the crash recovery start point forward in time so that there is less of the logical log 18 to replay during roll forward. These two operations also impact the contents of the fast recovery log 154.

There are two kinds of pages that end up in the fast recovery log 154. After (or before) a page 24 is updated, a copy of it is put into the fast recovery log 154. Also, copies of the hot pages 24 can be put into the fast recovery log 154 periodically. Only one copy of a page 24 needs to be put into the fast recovery log 154 per crash recovery scenario. As the oldest LSN is moved during normal flushing, this effects the contents of the fast recovery log 154. However, the pages 24 put into the fast recovery log 154 can be flushed to it in a lazy fashion, since they are not needed for transactional correctness.

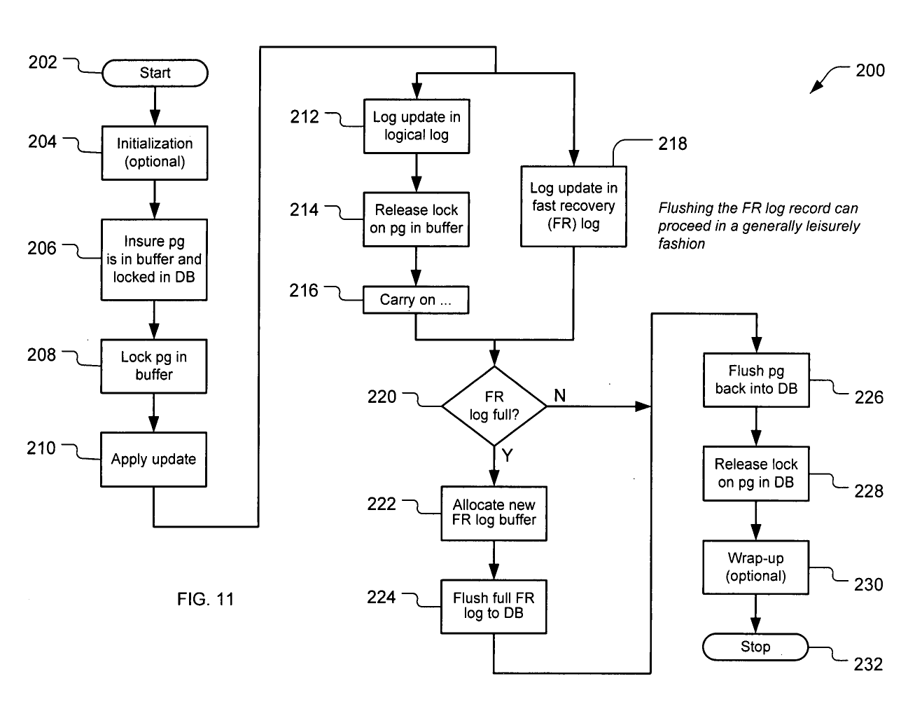

FIG. 11 is a flow chart depicting an overview of an update process 200 for updating the data in the DBMS 152 in accord with the present invention. In a step 202 the update process 200 starts and in a step 204 optional general initialization can be performed.

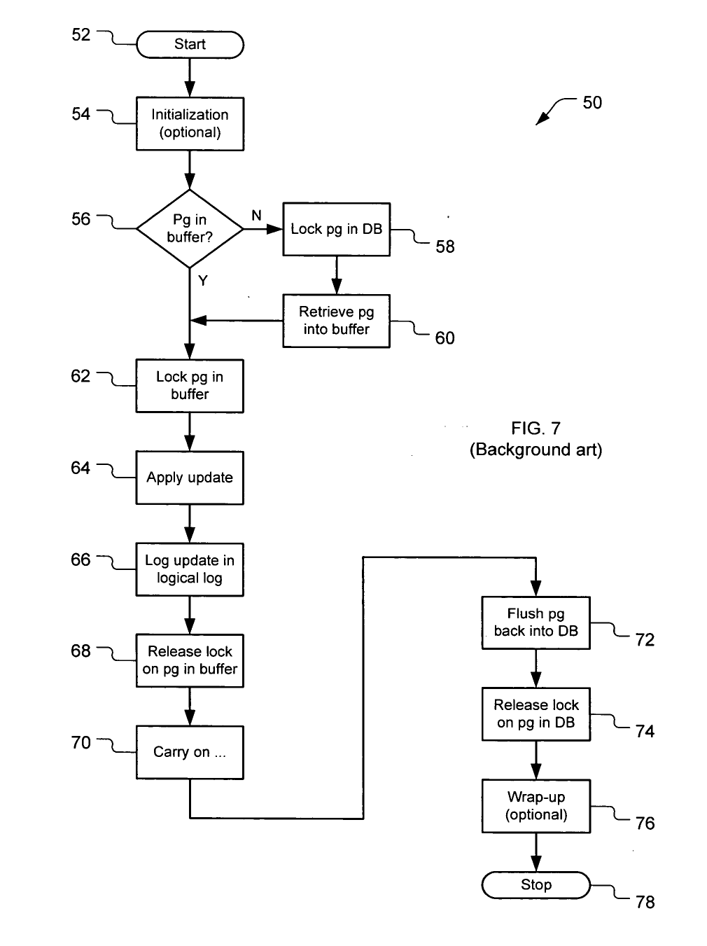

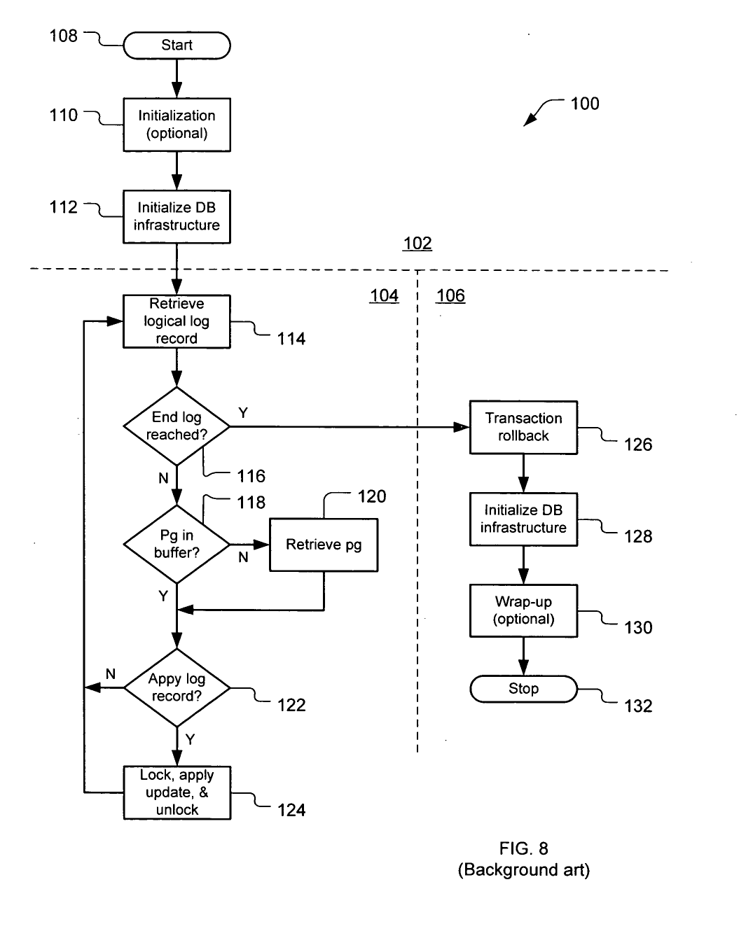

In a step 206, the database engine 156 insures that the page 24 containing the data about to be updated is already present in the buffer pool 16 (e.g., using steps 56-58 of FIG. 7).

In a step 208, the database engine 156 locks the subject page 24 in the buffer pool 16, thus halting other activity on it while the update is being performed. In a step 210, the database engine 156 applies the update as needed to the page 24 of locked data. The page 24 is now a dirty page 24.

In a step 212 the database engine 156 records the update in the logical log 18, in a step 214 it releases the lock on the page 24 in the bufferpool 16, and in a step 216 it carries on. Roughly concurrently with steps 212-216, in a step 218 the database engine 156 records the update destined for the fast recovery log 154. This can be done in a leisurely manner. The page 24 can be flushed into the fast recovery log 154 immediately. But for performance purposes it can be advantageous to first copy a page 24 into a buffer and flush the buffer when it gets full. This performance option works because the pages 24 in the buffer (intended for the fast recovery log 154) are not required for crash recovery correctness. If this buffer is lost, performance during crash recovery may be degraded somewhat but crash recovery can otherwise still proceed using the existing fast recovery log 154 and the logical log 18 in persistent storage.

After steps 216 and 218, a determination is made if the fast recovery log 154 is full. If so, in a step 222 new storage is allocated for additional update records 158 and in a step 224 the existing update records 158 in the fast recovery log 154 are flushed to the database 14. Otherwise, things are fine for the time being.

In a step 226, at some later point, the dirty page 24 is flushed back into the database 14 and, after this, in a step 228 the database engine 156 releases the lock on the specific portions of the page 24 in the database 14 that were locked back in step 206.

Finally, in a step 230, optional general wrap-up can be performed and in a step 232 the update process 200 is finished.

FIG. 12 is a flow chart depicting a crash recovery process 250 in accord with the present invention. As was the case described for a conventional DBMS 10, crash recovery has three basic phases. The first of these is a pre-transaction recovery phase 252 for infrastructure initialization of the database engine 156. The second basic phase is a transaction recovery phase 254. And the third basic phase is a post-transaction recovery phase 256 for further infrastructure initialization of the database engine 156.

In an actual crash recovery, the update pages 158 from the fast recovery log 154 are used to “seed” the buffer pool 16 with the pages 24 required for transaction recovery. However, unlike conventional schemes and because in the crash recovery system 150 they are stored in a large, contiguous storage format, the update pages 158 can be efficiently read from the fast recovery log 154 into the buffer pool 16 using large block, sequential I/O. When log replay starts, all of the pages 24 required are now already in the buffer pool 16 and no random I/O occurs.

Accordingly, in a step 258 the crash recovery process 250 starts and in a step 260 optional general initialization can be performed. In a step 262, the database engine 156 infrastructure is initialized. This includes allocating required resources such as memory, opening storage required for the database 14, etc. This ends the pre-transaction recovery phase 252, which is not particularly germane to this disclosure and therefore not discussed further.

In step 264, update pages 158 required for logical replay are retrieved from the fast recovery log 154 using big block, sequential I/O. All the required images are seeded into the buffer pool 16 prior to starting the transaction roll forward or logical replay sub-phase, i.e., starting the prior art crash recovery process 100.

Although seeming simple, the difference between crash recovery process 100 and crash recovery process 250 is considerable. Most, if not all, of the necessary pages 24 are now already present in the buffer pool 16, page faults during logical replay are now minimal and logical replay proceeds much more efficiently. This is because the cost to actually apply a log record 28 versus just getting a lock is minuscule when the page 24 that the log record 28 references is already in the buffer pool 16. Most of the CPU intensive work in applying log records 28 is in assembling them, which is done with either approach. The trade off between the two approaches thus is the cost of getting a lock versus the cost of applying the log record 28.

An exemplary implementation of the present invention utilized a database server, Informix XPS, with Sun/Solaris 6CPU hardware applying the TPC-C benchmark application. TPC-C is provided by the Transaction Performance Processing Counsel (TPC). It is a write intensive on-line transaction processing benchmark widely used by hardware and software vendors to measure transaction performance. Here the TPC-C application was allowed to run for 18 minutes to warm up the buffer pool. The TPC-C application was set up to max out performance (8000 TPM) on the machine. After the buffer pool was fully warmed up, a synchronous checkpoint was done recorded. This gave a consistent starting point for logical replay to begin. Then the TPC-C application was allowed to run for 12 minutes, thus providing the log data that crash recovery would have to replay.

Without the fast recovery log recovery took 25 minutes, and with it recovery took 3.5 minutes. Of those 3.5 minutes, approximate one-half were spent applying data to the buffer pool from the fast recovery log.

It can now be appreciated that the inventive approach provides numerous notable advantages. It improves data recovery time and operational performance through a more systematic process to reduce random I/O. Moreover, it permits the use of a big, block sequential I/O as a tool to increase the time and efficiency of data recovery and to free up memory for other operations. Further, once the database is recovered, the buffer pool is “warm”, allowing applications to achieve peak performance much sooner.

These advantages can be extremely important in a clustered environment. As shared nothing architecture continues to expand its influence, the techniques need to be developed that enhance its use. This invention is perfect for the N+1, N−1 failover strategy.

While various embodiments have been described above, it should be understood that they have been presented by way of example only, and not limitation. Thus, the breadth and scope of the invention should not be limited by any of the above described exemplary embodiments, but should be defined only in accordance with the following claims and their equivalents.

What is claimed is:

1. A method for crash recovery in a data base management system (DBMS), the method comprising:
loading a plurality of pages of data sequentially as a block from a fast recovery log into a bufferpool, wherein said pages have respectively been pre-stored into said fast recovery log to construct said block; and
applying a plurality of logical operations from a logical log to said pages in said bufferpool to return the DBMS to a transactionally consistent state.

2. The method of claim 1, wherein said block includes all said pages that said plurality of logical operations require to return the DBMS to said transactionally consistent state.

3. The method of claim 1, wherein said plurality of pages in said fast recovery log are images of said data in said bufferpool before respective instances of said logical operations were previously applied to said data.

4. The method of claim 1, wherein said plurality of pages in said fast recovery log are images of said data in said bufferpool after respective instances of said logical operations were previously applied to said data.

5. The method of claim 1, further comprising initializing the infrastructure of the DBMS prior to said loading of said block into said bufferpool.

6. A method for building a fast recovery log for use in crash recovery in a data base management system (DBMS) having a bufferpool and pages of data, the method comprising:
receiving a transaction to update the data in a particular page;
insuring that said particular page is in the bufferpool;
updating said particular page in the bufferpool in accord with said transaction;
logging said transaction into a logical log in non-volatile storage;
recording said particular page in a fast recovery log in non-volatile storage; and
wherein said insuring occurs after said receiving, said updating occurs after said insuring, said logging occurs after said updating, and said recording occurs after said insuring.

7. The method of claim 6, further comprising:
locking said particular page in the bufferpool prior to said updating; and
unlocking said particular page in the bufferpool subsequent to said logging.

8. The method of claim 6, wherein the DBMS includes the pages of the data in a database, and the data comprises rows in tables, and wherein said insuring includes:
locking the rows of the data in the database that are to be subject to said transaction; and
retrieving said particular page into the bufferpool from the database; and
after said updating, the method further comprising:
flushing said particular page from the bufferpool into the database; and
unlocking the rows of the data in the database that have been updated by said transaction.

9. The method of claim 6, wherein said recording takes place before said updating, thereby providing a before image of said particular page as updated by said transaction in said fast recovery log.

10. The method of claim 6, wherein said recording takes place after said updating, thereby providing an after image of said particular page as updated by said transaction in said fast recovery log.

11. An improved data base management system (DBMS) of the type in which:
a database engine performs an update on data in a page in a database by moving the page into a bufferpool, applying the update to the data in the page in the bufferpool, and writing the page back into the database from the bufferpool; and
the database engine stores a log record for the update in a logical log to permit recovery of the database to a transactionally consistent state after an event where the bufferpool is disrupted before the page in the bufferpool is written into the database;
the improvement comprising:
a fast recovery log in which the database engine stores the page of data in a manner that facilitates sequential loading of the page along with a plurality of other such pages into the bufferpool, thereby seeding the bufferpool before the database engine applies the log record after a disruption.

12. A system for crash recovery in a data base management system (DBMS) having a bufferpool, a plurality of pages of data in a database, and a logical log to contain log records of updates to the data, the system comprising:
a fast recovery log to contain seed pages of the data;
a database engine to receive the updates for particular data from the plurality of pages of the data in the database;
said database engine to insure that the pages containing said particular data are in the bufferpool;
said database engine to apply the updates;
said database engine to log the log records of the updates to the data into the logical log;
said database engine to record the particular pages as at least one sequential block of said seed pages in said fast recovery log;
said database engine to retrieve said sequential blocks of said seed pages in said fast recovery log into the bufferpool; and
said database engine to replay said log records of the updates to the data from the logical log, thereby returning the DBMS to a transactionally consistent state.

13. The system of claim 12, wherein said database engine further to record a single said sequential block that includes all current said seed pages.

14. The system of claim 12, wherein said database engine further to record said seed pages as images of the particular pages in the bufferpool before applying the updates to the particular pages.

15. The system of claim 12, wherein said database engine further to record said seed pages as images of the particular pages in the bufferpool after applying the updates to the particular pages.

16. The system of claim 12, wherein said database engine further to initialize the infrastructure of the DBMS prior to retrieving said sequential blocks of said seed pages or receive new instances of the updates.

17. The system of claim 12, wherein said database engine to further lock a respective said particular page in the bufferpool prior to applying a respective update and to unlock said respective particular page in the bufferpool subsequent to said logging the log record of the respective update to the data into the logical log.

18. The system of claim 12, wherein the data in the database comprises rows in tables, and wherein:
said database engine further to lock the rows of the data in the database that are said particular data to be subject to a respective update;
said database engine further to retrieve said particular data into the bufferpool from the database;
said database engine further to flush said particular data from the bufferpool into the database; and
said database engine further to unlock the rows of the data in the database that have been updated.

19. A computer program, embodied on a computer readable storage medium, for crash recovery in a data base management system (DBMS), the computer program comprising:
a code segment that loads a plurality of pages of data sequentially as a block from a fast recovery log into a bufferpool when said pages have respectively been pre-stored into said fast recovery log to construct said block; and
a code segment that applies a plurality of logical operations from a logical log to said pages in said bufferpool to return the DBMS to a transactionally consistent state.

20. A computer program, embodied on a computer readable storage medium, for building a fast recovery log for use in crash recovery in a data base management system (DBMS) having a bufferpool and pages of data, the computer program comprising:
a code segment that receives a transaction to update the data in a particular page;
a code segment that insures that said particular page is in the bufferpool;
a code segment that updates said particular page in the bufferpool in accord with said transaction;
a code segment that logs said transaction into a logical log in non-volatile storage; and
a code segment that records said particular page in a fast recovery log in non-volatile storage.
